(19) United States
(12) Patent Application Publication
(10) Pub. No.: US 2025/0167259 A1
(43) Pub. Date: May 22, 2025

(54) METHOD FOR MANUFACTURING FUEL BATTERY

(71) Applicant: TOYOTA JIDOSHA KABUSHIKI KAISHA, Toyota-shi (JP)

(72) Inventors: Kazunori SHIBATA, Mishima-shi (JP); Hitoshi HAMADA, Gotemba-shi (JP); Makoto OHATA, Susono-shi (JP); Kotaro IKEDA, Susono-shi (JP); Hiroaki TAKEUCHI, Susono-shi (JP)

(21) Appl. No.: 18/912,711

(22) Filed: Oct. 11, 2024

(30) Foreign Application Priority Data
Nov. 21, 2023 (JP) 2023-197260

(51) Int. Cl. H01M 8/0273; H01M 8/0202

(52) U.S. Cl. CPC H01M 8/0273; H01M 8/0202

(57) ABSTRACT

A method for manufacturing fuel cells may include forming an adhesive layer by applying a pressure-sensitive adhesive along a predetermined seal line on a surface of a supporting frame which supports a membrane electrode assembly; bringing a separator to the surface of the supporting frame until the separator contacts the adhesive layer; and bonding the supporting frame and the separator together by applying a compressive force to the supporting frame and the separator which contact each other via the adhesive layer. In bringing a separator to the surface of the supporting frame, in a cross-sectional view perpendicular to a longitudinal direction of the seal line, a distance between a surface of the adhesive layer and a surface of the separator facing the surface of the adhesive layer may be minimum at a specific point and increases monotonically from the specific point in a width direction of the seal line.

### REFERENCE TO RELATED APPLICATIONS

This application claims priority to Japanese Patent Application No. 2023-197260 filed on Nov. 21, 2023, the contents of which are hereby incorporated by reference into the present application.

### BACKGROUND ART

The technology disclosed herein relates to methods for manufacturing fuel cells.

A method for manufacturing fuel cells is described in Japanese Patent Application Publication No. 2020-113391. In this manufacturing method, a separator is bonded using an adhesive to a surface of a support frame that supports a membrane electrode assembly.

### SUMMARY

Conventionally, heat-activated adhesives have been used to manufacture fuel batteries. Instead, pressure-sensitive adhesives may be used. However, heat-activated adhesives undergo a phase change from solid to liquid during a bonding process, whereas pressure-sensitive adhesives do not undergo such a phase change. Therefore, air bubbles trapped between an adhesive layer formed by the pressure-sensitive adhesive and a separator may remain in the adhesive layer.

In view of the above, the disclosure herein provides a technique for suppressing air bubbles from remaining in an adhesive layer even when a pressure-sensitive adhesive is used.

The technique disclosed herein is embodied as a method for manufacturing fuel cells. This method for manufacturing fuel cells may comprise forming an adhesive layer by applying a pressure-sensitive adhesive along a predetermined seal line on a surface of a supporting frame which supports a membrane electrode assembly; bringing a separator to the surface of the supporting frame until the separator contacts the adhesive layer formed on the supporting frame; and bonding the supporting frame and the separator together by applying a compressive force to the supporting frame and the separator which contact each other via the adhesive layer. In the bringing a separator to the surface of the supporting frame, in a cross-sectional view perpendicular to a longitudinal direction of the seal line, a distance between a surface of the adhesive layer and a surface of the separator facing the surface of the adhesive layer may be minimum at a specific point and increases monotonically from the specific point in a width direction of the seal line.

In the method for manufacturing fuel cells described above, the support frame and the separator are bonded to each other via the adhesive layer formed by the pressure-sensitive adhesive. Specifically, the pressure-sensitive adhesive is first applied to the surface of the support frame along the predetermined seal line to form the adhesive layer. Then, the separator is brought closer to the surface of the support frame until it contacts the adhesive layer on the support frame. At this point, in the cross-sectional view perpendicular to the longitudinal direction of the seal line, the distance between the surface of the adhesive layer and the surface of the separator facing the surface of the adhesive layer is minimum at the specific point and increases monotonically from the specific point in the width direction of the seal line. Thereafter, a compressive force is applied to the support frame and the separator, so that the support frame and the separator are bonded to each other via the adhesive layer. In this configuration, the adhesive layer and the separator first contact each other at the specific point where the distance between the surface of the adhesive layer and the surface of the separator is minimum, and then contact each other therefrom along the width direction of the seal line. Therefore, air bubbles can be prevented from being trapped between the adhesive layer and the separator. Even if air bubbles are trapped between the adhesive layer and the separator, they can be pushed outside in the width direction of the seal line from the specific point. This can suppress the formation of air bubbles in the adhesive layer formed by the pressure-sensitive adhesive.

### BRIEF DESCRIPTION OF DRAWINGS

FIG. 1 shows a schematic diagram of fuel cells 10 according to an example.

FIG. 2 shows a schematic exploded view of a fuel cell 12.

FIG. 3 shows an adhesive layer 24 applied along a predetermined seal line on a surface of a support frame 20. That is, the area where the adhesive layer 24 is applied indicates the predetermined seal line.

FIGS. 4A to 4C show a flow of a method for manufacturing the fuel cells 10. FIG. 4A shows a cross-sectional view along a line IV-IV. FIG. 4B shows a step of bringing separators 16, 18 closer to the surface of the support frame 20. FIG. 4C shows the support frame 20 and the separators 16, 18 are bonded to each other via adhesive layers 24, 26.

FIGS. 5A to 5C show some variants of the adhesive layers 24 and 26, each corresponding to the cross-sectional view of FIG. 4A.

FIGS. 6A and 6B show variants in which the separators 16 and 18 are provided with protrusions 32 instead of the adhesive layers 24 and 26, each corresponding to the cross-sectional view in FIG. 4A.

FIGS. 7A to 7C show another method of manufacturing the fuel cells 10.

### DESCRIPTION

In a second aspect according to the first aspect, in the forming an adhesive layer, the adhesive may be applied such that in the cross-sectional view perpendicular to the longitudinal direction of the seal line, a thickness of the adhesive is maximum at the specific point and decreases monotonically from the specific point in the width direction of the seal line. This configuration suppresses the formation of air bubbles in the adhesive layer by adjusting the thickness of the adhesive layer in the cross-sectional view perpendicular to the longitudinal direction of the seal line.

In a third aspect according to the first or second aspect, in the forming an adhesive layer, the adhesive may be applied such that in the cross-sectional view perpendicular to the longitudinal direction of the seal line, the adhesive layer has a symmetrical shape. In this configuration, in the cross-sectional view perpendicular to the longitudinal direction of the seal line, the adhesive layer and the separator gradually come into contact with each other from the center of the adhesive layer to both sides in the width direction. Therefore, air bubbles can be prevented from being trapped between the adhesive layer and the separator, and even if air bubbles are trapped between the adhesive layer and the separator, they can be pushed outside from the center toward both sides in the width direction of the seal line.

Alternatively, in another embodiment, the point where the thickness of the adhesive layer is maximum in the cross-sectional view perpendicular to the longitudinal direction of the seal line may be located at one end of the seal line in the width direction of the seal line. In this case, the thickness of the adhesive layer may decrease monotonically from the point toward the other end of the seal line. This configuration can also prevent air bubbles from being trapped between the adhesive layer and the separator, and even if air bubbles are trapped between the adhesive layer and the separator, they can be pushed outside from the one end of the seal line to the other end.

In a fourth aspect according to any of the first to third aspects, in the bringing a separator to the surface of the supporting frame, in the cross-sectional view perpendicular to the longitudinal direction of the seal line, the surface of the separator facing the surface of the adhesive layer may protrude toward the adhesive layer, and a protruding length of the surface of the separator may be maximum at the specific point and decreases monotonically from the specific point in the width direction of the seal line. In this configuration, the protrusion of the separator can suppress the formation of air bubbles in the adhesive layer.

In one or more of the above aspects, the width of the adhesive layer in the cross-sectional view perpendicular to the longitudinal direction of the seal line may be 10 mm or less. Additionally or alternatively, in the cross-sectional view perpendicular to the longitudinal direction of the seal line, a difference between the maximum and minimum thicknesses of the adhesive layer may be 20 micrometers or more. These configurations can suppress the formation of air bubbles in the adhesive layer more efficiently.

In one or more of the above aspects, viscoelasticity of the adhesive forming the adhesive layer may be in the range from 105 Mpa to 107 MPa. According to the technology disclosed herein. even with such an adhesive, the formation of air bubbles in the adhesive layer can be suppressed.

The technology disclosed herein is also embodied in another method for manufacturing fuel cells. This method for manufacturing fuel cells may comprise forming an adhesive layer by applying a pressure-sensitive adhesive along a predetermined seal line on a surface of a first separator which constitutes a fuel cell; bringing a second separator to the surface of the first separator until the second separator contacts the adhesive layer formed on the first separator, wherein the second separator constitutes another fuel cell; bonding the first separator and the second separator together by applying a compressive force to the first separator and the second separator which contact each other via the adhesive layer. In the bringing a second separator to the surface of the first separator, in a cross-sectional view perpendicular to a longitudinal direction of the seal line, a distance between a surface of the adhesive layer and a surface of the second separator facing the surface of the adhesive layer may be minimum at a specific point and increase monotonically from the specific point in a width direction of the seal line.

In the method for manufacturing fuel cells, the first separator constituting the fuel cell and the second separator constituting the other fuel cell are bonded together via the adhesive layer formed by the pressure-sensitive adhesive. In other words, components to be bonded via the adhesive layer in this method for manufacturing fuel cells are different from those in the above-described method for manufacturing fuel cells. Even in this configuration, the adhesive layer and the second separator first contact each other at the specific point where the distance between the surface of the adhesive layer and the surface of the second separator is minimum, and then contact each other therefrom along the width direction of the seal line. Therefore, the formation of air bubbles in the adhesive layer can be suppressed.

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved methods for manufacturing fuel cells.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

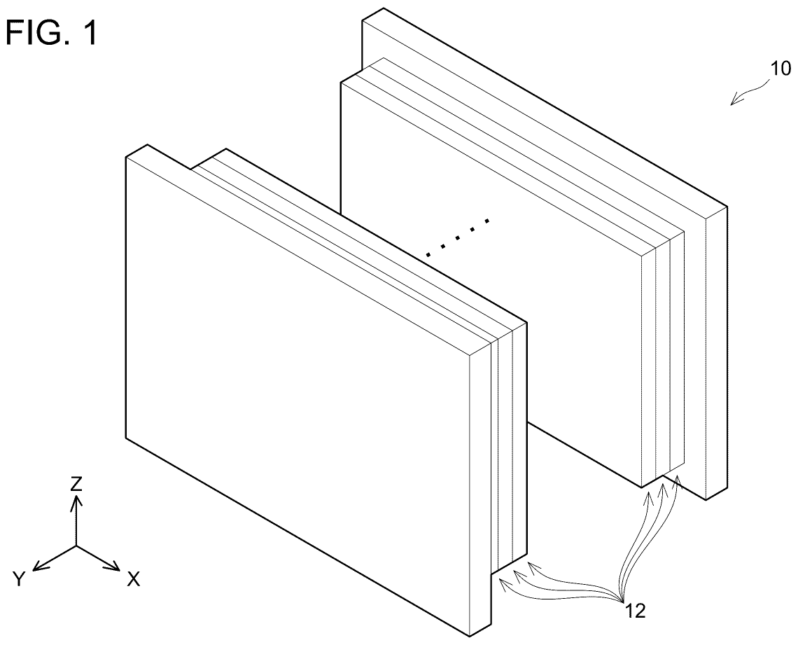

With reference to the drawings, fuel cells 10 and a method for manufacturing the same according to an embodiment will be described. As shown in FIG. 1, the fuel cells 10 comprises a plurality of fuel cells 12. Each fuel cell 12 is arranged parallel to X and Z axes, and the fuel cells 12 are stacked along a Y axis. As described in detail below, each fuel cell 12 is a component capable of generating electricity on its own. The fuel cells 10 may be used in a vehicle powered by fuel cells such as a fuel cell vehicle, but the application of the fuel cells 10 is not limited thereto.

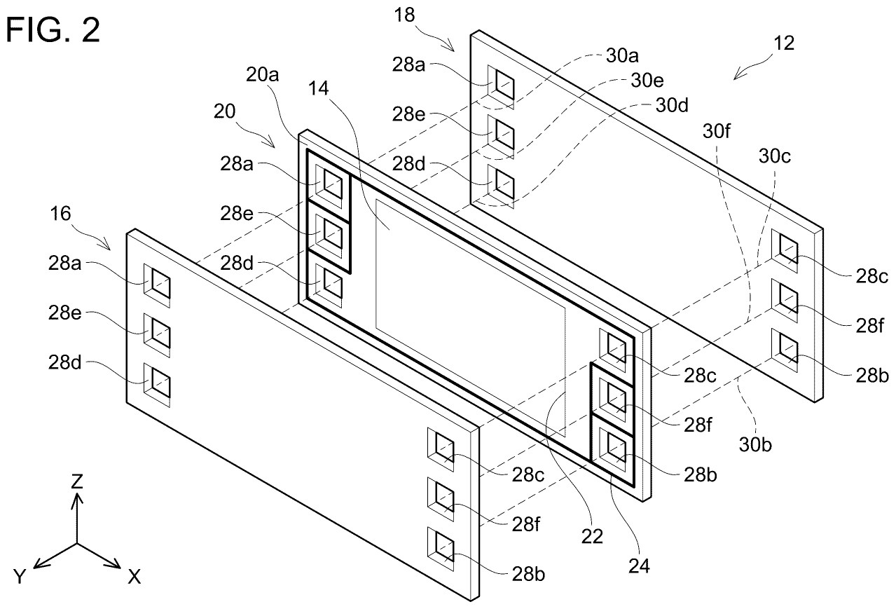

As shown in FIG. 2, each fuel cell 12 includes a membrane electrode assembly (MEA) 14, an anode-side separator 16, a cathode-side separator 18, and a support frame 20. The MEA 14 includes an electrolyte membrane, an anode catalyst layer located on one surface of the electrolyte membrane, and a catalyst layer located on the other surface of the electrolyte membrane, although these are not shown. The MEA 14 is supported by the support frame 20. The MEA 14 and the support frame 20 are interposed between the anode-side separator 16 and the cathode-side separator 18. Each fuel cell 12 may further include an anode-side gas diffusion layer and a cathode-side gas diffusion layer on opposing surfaces of the MEA 14. That is, the MEA 14 may form, together with the anode-side gas diffusion layer and the cathode-side gas diffusion layer, a membrane electrode and gas diffusion layer assembly (MEGA).

The anode-side separator 16 and the cathode-side separator 18 are plate-shaped members and are constituted of a gas impermeable conductive material. Each of the separators 16, 18 may be formed of a metal plate such as titanium or stainless steel. Each of the separators 16, 18 has six manifold holes 28a to 28f. These manifold holes 28a to 28f form manifolds 30a, 30c, and 30e that supply hydrogen gas, air, and cooling medium, respectively, to the fuel cell 12 and manifolds 30b, 30d, and 30f that collect unreacted hydrogen gas, unreacted air, and unreacted cooling medium, respectively, from the fuel cell 12.

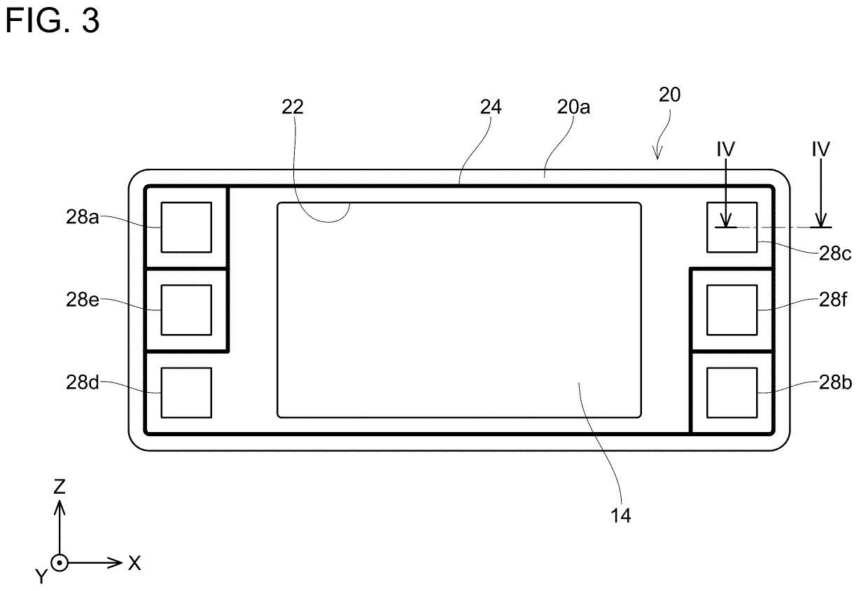

As shown in FIGS. 2 and 3, the support frame 20 has a frame shape with an opening 22. The MEA 14 is located in the opening 22 of the support frame 20. The support frame 20 surrounds the MEA 14. The support frame 20 is constituted of a thermosetting resin such as epoxy resin or phenolic resin, although the material of the support frame 20 is not limited thereto. As with the separators 16 and 18, the support frame 20 also has six manifold holes 28a to 28f.

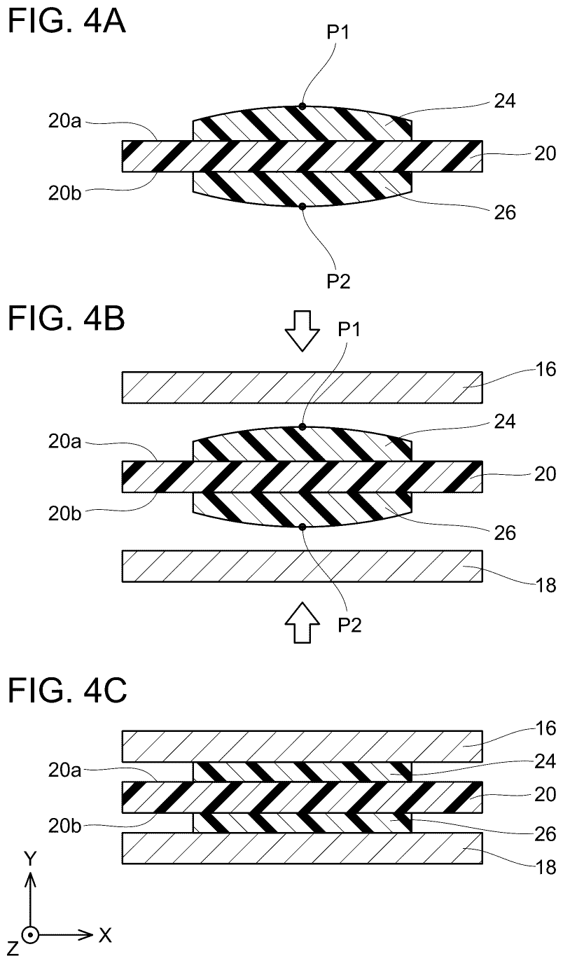

One surface 20a of the support frame 20 faces the anode-side separator 16 and is bonded to the anode-side separator 16 via a first adhesive layer 24. The first adhesive layer 24 is constituted of a pressure-sensitive adhesive (PSA). The first adhesive layer 24 is along a predetermined seal line on the one surface 20a of the support frame 20. The seal line for the first adhesive layer 24 is defined to surround the opening 22 and the respective manifold holes 28a to 28f in the support frame 20. The other surface 20b of the support frame 20 faces the cathode-side separator 18 and is bonded to the cathode-side separator 18 via a second adhesive layer 26 (see FIG. 4(a) to (c)). The second adhesive layer 26 is also constituted of the pressure-sensitive adhesive (PSA). The second adhesive layer 26 is along a predetermined seal line on the other surface 20b of the support frame 20. The seal line for the second adhesive layer 26 is also defined to surround the opening 22 and the respective manifold holes 28a to 28f in the support frame 20.

Referring to FIGS. 3 and 4, a method for manufacturing the fuel cells 10 is described. As shown in FIGS. 3 and 4(A), the method includes a step of forming the adhesive layers 24 and 26 on the corresponding surfaces 20a and 20b of the support frame 20 that supports the MEA 14. In this step, the pressure-sensitive adhesive is applied to the surfaces 20a, 20b of the support frame 20 along the predetermined seal lines. Consequently, the adhesive layers 24 and 26 are formed on the surfaces 20a and 20b of the support frame 20, respectively. The method of applying the adhesive is not particularly limited. In an example, the adhesive may be applied by inkjet printing, screen printing, or the like.

As shown in FIG. 4A, in the step of forming the adhesive layers 24 and 26, the adhesive is applied such that surfaces of the adhesive layers 24 and 26 are convex as viewed in a cross-sectional view perpendicular to the longitudinal direction of the seal line. Thus, for example, the thickness of the first adhesive layer 24 is maximum at a first point P1 and decreases monotonically from the first point P1 in the width direction of the seal line (i.e., the X direction). Here, “decrease monotonically” means to decrease continuously or intermittently without an increase. The position of the first point P1 where the thickness of the first adhesive layer 24 is maximum is not particularly limited. In this embodiment, in the cross-sectional view perpendicular to the longitudinal direction of the seal line, the first point P1 of the first adhesive layer 24 is located in the center of the seal line in the width direction (i.e., the X direction) and the first adhesive layer 24 has a symmetrical shape, although this is merely an example. Similarly, the thickness of the second adhesive layer 26 is maximum at a second point P2 and decreases monotonically from the second point P2 in the width direction (i.e., the X direction) of the seal line. In the cross-sectional view perpendicular to the longitudinal direction of the seal line, the second adhesive layer 26 may have a shape that is vertically symmetrical or asymmetrical with that of the first adhesive layer 24.

As shown in FIG. 4B, the method includes a step of bringing the separators 16 and 18 closer to the surfaces 20a and 20b of the support frame 20, respectively. In this step, the separators 16 and 18 are brought closer to the surfaces 20a and 20b of the support frame 20 until they contact the adhesive layers 24 and 26 on the support frame 20. Consequently, the anode-side separator 16 is positioned in contact with the first adhesive layer 24 on the one surface 20a of the support frame 20, and the cathode-side separator 18 is positioned in contact with the second adhesive layer 26 on the other surface 20b of the support frame 20.

As mentioned above, the surfaces of the adhesive layers 24 and 26 are each convex. Therefore, as the anode-side separator 16 is brought closer to the first adhesive layer 24, in the cross-sectional view perpendicular to the longitudinal direction of the seal line, the distance between the surface of the first adhesive layer 24 and the surface of the anode-side separator 16 facing the surface of the first adhesive layer 24 is minimum at the first point P1 and increases monotonically from the first point P1 in the width direction of the seal line (i.e., the X direction). Here, “increase monotonically” means to increase continuously or intermittently without a decrease. Similarly, in the cross-sectional view perpendicular to the longitudinal direction of the seal line, the distance between the surface of the second adhesive layer 26 and the surface of the cathode-side separator 18 facing the surface of the second adhesive layer 26 is also minimum at the second point P2 and increases monotonically from the second point P2 in the width direction of the seal line (i.e., the X direction).

According to the above configuration, the surfaces of the adhesive layers 24, 26 start contacting the surfaces of the separators 16, 18 at the first point P1 and the second point P2. Thereafter, the surfaces of the adhesive layers 24, 26 gradually contact the separators 16 and 18 in the width direction of the seal line (i.e., the X direction). Therefore, air bubbles can be prevented from being trapped between the adhesive layers 24, 26 and the separators 16, 18. Even if air bubbles are trapped between the adhesive layers 24, 26 and the separators 16, 18, they can be pushed outside in the width direction of the seal line from the specific point(s) (i.e., the first point P1, the second point P2). This can suppress the formation of air bubbles in the adhesive layers 24, 26 formed by the pressure-sensitive adhesive.

As shown in FIG. 4C, the method includes a step of bonding the support frame 20 and the separators 16 and 18 together. In this step, a compressive force is applied to the support frame 20 and the separators 16 and 18, which are in contact via the adhesive layers 24 and 26. Consequently, the anode-side separator 16 is bonded to the support frame 20 via the first adhesive layer 24, and the cathode-side separator 18 is bonded to the support frame 20 via the second adhesive layer 26. The method of bringing the separators 16, 18 closer to the support frame 20 and the method of applying a compressive force to the support frame 20 and the separators 16, 18 are not particularly limited. In one example, a press machine or the like can be used for these steps.

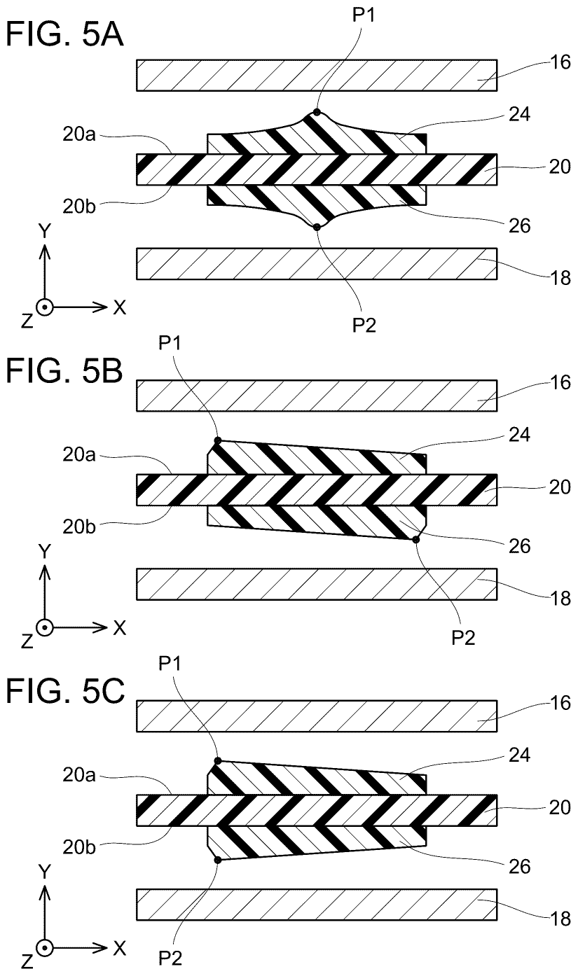

FIGS. 5A to 5C show some variants of the adhesive layers 24, 26. As shown in FIG. 5A, in the cross-sectional view perpendicular to the longitudinal direction of the seal line, the surfaces of the adhesive layers 24 and 26 formed on the support frame 20 may be concavely curved only partially or over their entirety. Alternatively, as shown in FIGS. 5B and 5C, in the cross-sectional view perpendicular to the longitudinal direction of the seal line, each of the adhesive layers 24 and 26 formed on the support frame 20 may have a shape in which the thicknesses of the adhesive layers 24 and 26 are maximum at their ends in the width direction. In this case, the shapes of the two adhesive layers 24 and 26 may be asymmetrical vertically with respect to each other (see FIG. 5B) or symmetrical vertically with respect to each other (see FIG. 5C).

As mentioned above, the adhesive layers 24 and 26 are formed to surround the opening 22 and the respective manifold holes 28a to 28f of the support frame 20. Thus, the adhesive layers 24 and 26 each have a section adjacent to the manifold holes 28a to 28f and a section that is not adjacent to the manifold holes 28a to 28f. In the vicinity of the manifold holes 28a to 28f, a relatively high pressure acts on the adhesive layers 24 and 26. Therefore, the widths and/or thicknesses of the first adhesive layer 24 and the second adhesive layer 26 may be larger in the sections adjacent to the manifold holes 28a to 28f than in the sections that are not adjacent to the manifold holes 28a to 28f.

In the above embodiment and variants, the thicknesses of both the two adhesive layers 24 and 26 varies in the width direction. In contrast, in other embodiments, the thickness of only one of the two adhesive layers 24 and 26 may vary in the width direction. That is, the thickness of the other of the two adhesive layers 24, 26 may be constant in the width direction.

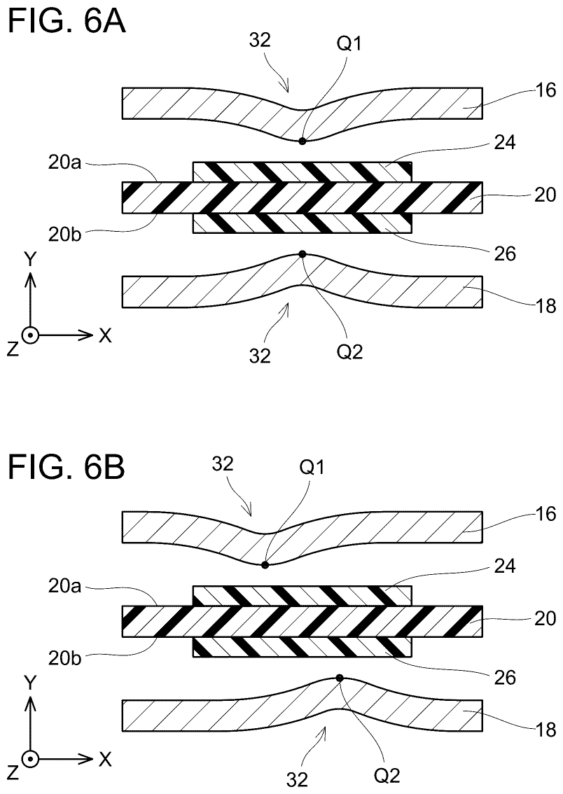

In the above embodiment and variants, the thicknesses of both the two adhesive layers 24 and 26 varies in the width direction. In contrast, as shown in FIGS. 6A and 6B, in other embodiments, the above-mentioned surface profiles of the adhesive layers 24 and 26 may be provided on the surfaces of the separators 16 and 18, which are to contact the adhesive layers 24 and 26. That is, protrusions 32 protruding toward the adhesive layers 24 and 26 may be provided on the surfaces of the separators 16 and 18, respectively. In this case, the protruding length of the protrusions 32 may be maximum at specific points Q1, Q2 and monotonically decrease from the points Q1, Q2 in the width direction of the seal line (i.e., the X direction).

In the above configuration, as the anode-side separator 16 approaches the first adhesive layer 24, the distance between the surface of the first adhesive layer 24 and the surface of the anode-side separator 16 facing the surface of the first adhesive layer 24 is minimum at the point Q1 and increases monotonically from the point Q1 in the width direction (i.e., the X direction) in the cross-sectional view perpendicular to the longitudinal direction of the seal line. This suppresses the formation of air bubbles in the adhesive layers 24 and 26.

In the above embodiment, the support frame 20 and the separators 16 and 18 are bonded together via the adhesive layers 24 and 26 formed by the pressure-sensitive adhesive. Alternatively or additionally, the anode-side separator 16 of a fuel cell 12 and the cathode-side separator 18 of another fuel cell 12 adjacent thereto may be bonded together via the adhesive layers 24 and 26 formed by the pressure-sensitive adhesive.

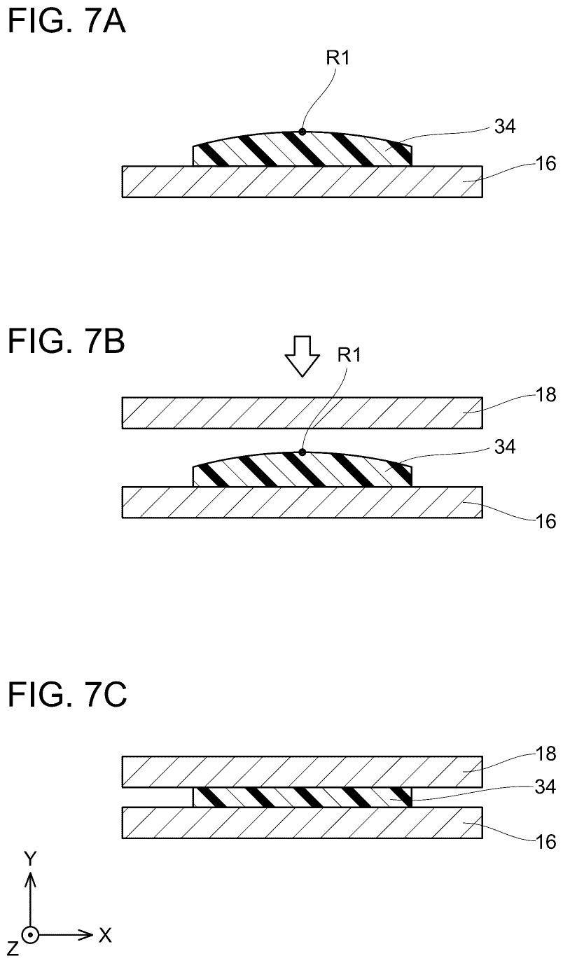

In that case, as shown in FIG. 7A, a method for manufacturing the fuel cells 10 includes a step of forming a third adhesive layer 34 on a surface of the anode-side separator 16. In this step, the pressure-sensitive adhesive is applied along a predetermined seal line on the anode-side separator 16. As with the adhesive layers 24 and 26 described above, the third adhesive layer 34 may have a thickness that varies in the width direction (see FIGS. 4 and 5).

As shown in FIG. 7B, the method includes a step of bringing the cathode-side separator 18 of the other fuel cell 12 closer to the surface of the anode-side separator 16. In this step, the cathode-side separator 18 is brought closer to the anode-side separator 16 until it contacts the third adhesive layer 34 on the anode-side separator 16. Consequently, the cathode-side separator 18 is positioned in contact with the third adhesive layer 34 on the anode-side separator 16. This step may be performed simultaneously with the step described referring to FIG. 4B.

The third adhesive layer 34 has a thickness that varies in the width direction of the seal line (i.e., the X direction). Therefore, as the cathode-side separator 18 is brought closer to the third adhesive layer 34, the distance between the surface of the third adhesive layer 34 and the surface of the cathode-side separator 18 facing the surface of the third adhesive layer 34 is minimum at a specific point R1 and increases monotonically from the point R1 in the width direction of the seal line in the cross-sectional view perpendicular to the longitudinal direction of the seal line. This can suppress the formation of air bubbles in the third adhesive layer 34 formed by the pressure-sensitive adhesive.

As shown in FIG. 7C, the method includes a step of bonding the two separators 16, 18 together. In this step, a compressive force is applied to the two separators 16, 18 that are in contact via the third adhesive layer 34. Consequently, the two separators 16, 18 are bonded together via the third adhesive layer 34. Since the two separators 16, 18 are sealed by the third adhesive layer 34, a gasket which would be required between the two separators 16, 18 can be omitted. This step may be performed simultaneously with the step described referring to FIG. 4C.

In this embodiment, the anode-side separator 16 is an example of first separator in the technology disclosed herein, and the cathode-side separator 18 is an example of second separator in the technology disclosed herein. In a variant, the third adhesive layer 34 may be formed on the cathode-side separator 18 instead of the anode-side separator 16.

What is claimed is:

1. A method for manufacturing fuel cells, comprising:
forming an adhesive layer by applying a pressure-sensitive adhesive along a predetermined seal line on a surface of a supporting frame which supports a membrane electrode assembly;
bringing a separator to the surface of the supporting frame until the separator contacts the adhesive layer formed on the supporting frame; and
bonding the supporting frame and the separator together by applying a compressive force to the supporting frame and the separator which contact each other via the adhesive layer;
wherein
in the bringing a separator to the surface of the supporting frame, in a cross-sectional view perpendicular to a longitudinal direction of the seal line, a distance between a surface of the adhesive layer and a surface of the separator facing the surface of the adhesive layer is minimum at a specific point and increases monotonically from the specific point in a width direction of the seal line.

2. The method according to claim 1, wherein in the forming an adhesive layer, the adhesive is applied such that in the cross-sectional view perpendicular to the longitudinal direction of the seal line, a thickness of the adhesive is maximum at the specific point and decreases monotonically from the specific point in the width direction of the seal line.

3. The method according to claim 2, wherein in the forming an adhesive layer, the adhesive is applied such that in the cross-sectional view perpendicular to the longitudinal direction of the seal line, the adhesive layer has a symmetrical shape.

4. The method according to claim 1, wherein in the bringing a separator to the surface of the supporting frame, in the cross-sectional view perpendicular to the longitudinal direction of the seal line, the surface of the separator facing the surface of the adhesive layer protrudes toward the adhesive layer, and a protruding length of the surface of the separator is maximum at the specific point and decreases monotonically from the specific point in the width direction of the seal line.

5. A method for manufacturing fuel cells, comprising:
forming an adhesive layer by applying a pressure-sensitive adhesive along a predetermined seal line on a surface of a first separator which constitutes a fuel cell;
bringing a second separator to the surface of the first separator until the second separator contacts the adhesive layer formed on the first separator, wherein the second separator constitutes another fuel cell;
bonding the first separator and the second separator together by applying a compressive force to the first separator and the second separator which contact each other via the adhesive layer;
wherein
in the bringing a second separator to the surface of the first separator, in a cross-sectional view perpendicular to a longitudinal direction of the seal line, a distance between a surface of the adhesive layer and a surface of the second separator facing the surface of the adhesive layer is minimum at a specific point and increases monotonically from the specific point in a width direction of the seal line.
